(19) United States
(12) Patent Application Publication
(10) Pub. No.: US 2017/0344520 A1
(43) Pub. Date: Nov. 30, 2017

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: Kentaro Takahashi, Kawasaki-shi (JP)

(21) Appl. No.: 15/601,898

(22) Filed: May 22, 2017

(30) Foreign Application Priority Data
May 31, 2016 (JP) 2016-109338

(51) Int. Cl. G06F 17/21; G06F 9/44; G06F 17/22; G06F 17/30

(52) U.S. Cl. CPC G06F 17/214; G06F 17/30905; G06F 9/4406; G06F 17/2223

(57) ABSTRACT

An apparatus in which an application is operated on a virtual machine includes a setting unit configured to set a font corresponding to a set language of the virtual machine, a font cache generation unit configured to read a font file corresponding to the set font, and generate a font cache including a pointer pointing to a cache of the font file, a control unit configured to display a font used for the application on a display device, by using the font cache, and a change unit configured to change the font cache, when the set language of the virtual machine is changed.

### BACKGROUND OF THE INVENTION

### Field of the Invention

The aspect of the embodiments relates to an information processing apparatus that executes an application on a virtual machine, an information processing method, and a storage medium.

### Description of the Related Art

Virtual machine techniques for executing a computer program involving screen display have conventionally been known. With the technique, a character is displayed on a display screen with a font specified by the program. The font to be displayed may change in accordance with an execution environment of a virtual machine. Thus, the virtual machine has a function of setting a font of a character to be displayed. Generally, a standard setting file is used for the virtual machine for setting the font of the character to be displayed.

When the set language is changed after the virtual machine has been started, the font is also changed in accordance with the language after the change.

Japanese Patent Application Laid-Open No. 2014-149858, Japanese Patent Application Laid-Open No. 2005-196397, and Japanese Patent Application Laid-Open No. 2004-157502 each discuss a technique of changing a font of a character to be displayed in accordance with a set language.

Japanese Patent Application Laid-Open No. 2014-149858 discusses a technique of preventing playback interruption, due to disk seek while a content is played, with a language resource loaded and cached on a memory of a player device, when a digital versatile disk (DVD) is played. Unfortunately, the technique has a risk of a delay due to disk seek on the DVD for the reloading of the language resource, when a language is reselected.

Japanese Patent Application Laid-Open No. 2005-196397 discloses a technique in which a character is rendered with a font corresponding to a language set in an area of each user interface (UI), to be displayed without corrupting. Unfortunately, the language setting for each UI might lead to a high processing load.

Japanese Patent Application Laid-Open No. 2004-157502 discusses a technique in which language information is acquired from a property of an operated file, and the font file to be used is selected from a plurality of font files. Unfortunately, the technique involves processing of merging a plurality of selected fonts into a single cache, and this processing might impose a large load on the information processing apparatus.

### SUMMARY OF THE INVENTION

According to an aspect of the embodiments, an apparatus in which an application is operated on a virtual machine includes a setting unit configured to set a font corresponding to a set language of the virtual machine, a font cache generation unit configured to read a font file corresponding to the set font, and generate a font cache including a pointer pointing to a cache of the font file, a control unit configured to display a font used for the application on a display device, by using the font cache, and a change unit configured to change the font cache, when the set language of the virtual machine is changed.

Further features of the disclosure will become apparent from the following description of exemplary embodiments with reference to the attached drawings.

### BRIEF DESCRIPTION OF THE DRAWINGS

FIG. 1 is a schematic view illustrating an example of a hardware configuration of an information processing apparatus.

FIG. 2 is a schematic view illustrating an example of a configuration of a system established on the information processing apparatus.

FIG. 3 is a schematic view illustrating a configuration of a virtual machine.

FIG. 4 is a diagram illustrating an example of a description in a font setting file for each set language.

FIG. 5 is a diagram illustrating a font cache in a case where the set language is Japanese.

FIG. 6 is a diagram illustrating a font cache in a case where the set language is Chinese.

FIG. 7 is a diagram illustrating a difference in font between Japanese and Chinese.

FIG. 8 is a flowchart illustrating virtual machine start processing according to a first exemplary embodiment.

FIG. 9 is a flowchart illustrating character rendering processing according to the first exemplary embodiment.

FIG. 10 is a flowchart illustrating font cache generation processing according to the first exemplary embodiment.

FIG. 11 is a flowchart illustrating set language change processing according to a second exemplary embodiment.

FIG. 12 is a flowchart illustrating character rendering processing according to a third exemplary embodiment.

FIG. 13 is a schematic view illustrating a configuration of a virtual machine according to a fourth exemplary embodiment.

FIG. 14 is a flowchart illustrating external apparatus connection processing according to the fourth exemplary embodiment.

FIG. 15 is a flowchart illustrating set language change processing according to the first exemplary embodiment.

### DESCRIPTION OF THE EMBODIMENTS

Exemplary embodiments of the disclosure are described below in detail with reference to the appended drawings.

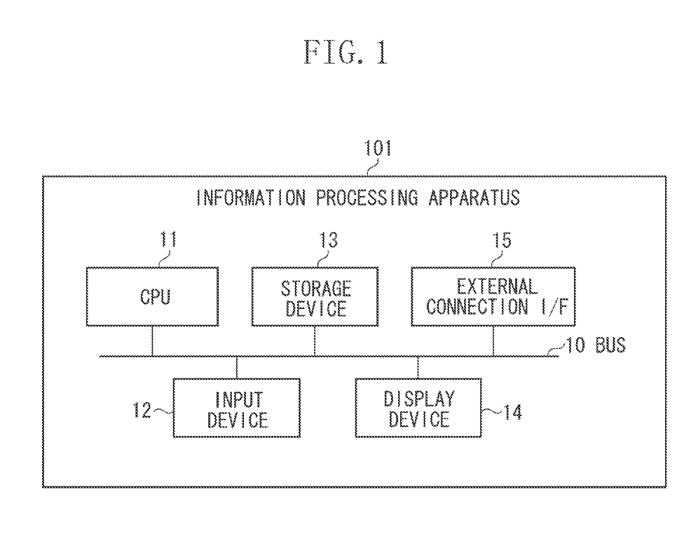

A first exemplar embodiment is described. FIG. 1 is a diagram illustrating an example of a hardware configuration of a general information processing apparatus 101. As illustrated in FIG. 1, the hardware configuration of the information processing apparatus 101 includes a central processing unit (CPU) 11.

Functions or flowcharts described below are implemented with the CPU 11 executing processing based on a program corresponding to aspects such as an execution environment for programs and applications described below, stored in a storage device 13.

The CPU 11 is connected to an input device 12, the storage device 13, a display device 14, and an external connection interface (I/F) 15, via a bus 10. The input device 12 is a keyboard and/or a mouse for inputting information. For example, the storage device 13 includes a read only memory (ROM), a random access memory (RAM), and a hard disk device, and stores the programs described above as well as data and the like used for processing based on the program. The display device 14 is a display that displays a screen and the like. The external connection I/F 15 is an interface for establishing various connections with a network interface and an external apparatus.

The CPU 11 can function as various units by executing the program. Alternatively, a control circuit such as an application specific integrated circuit (ASIC) that works together with the CPU 11 may function as the units. Furthermore, the CPU 11 and a control circuit that controls an operation of the information processing apparatus 101 may work together to implement the units. The configuration is not limited to that with a single CPU 11, and a configuration with a plurality of CPUs 11 may be employed. In such a configuration, the processing may be split among the plurality of the CPUs 11 to be executed. The plurality of CPUs 11 may be provided to a single computer, or may be provided to a plurality of physically different computers. The units implemented by the CPU 11 executing the program may be implemented by a dedicated circuit.

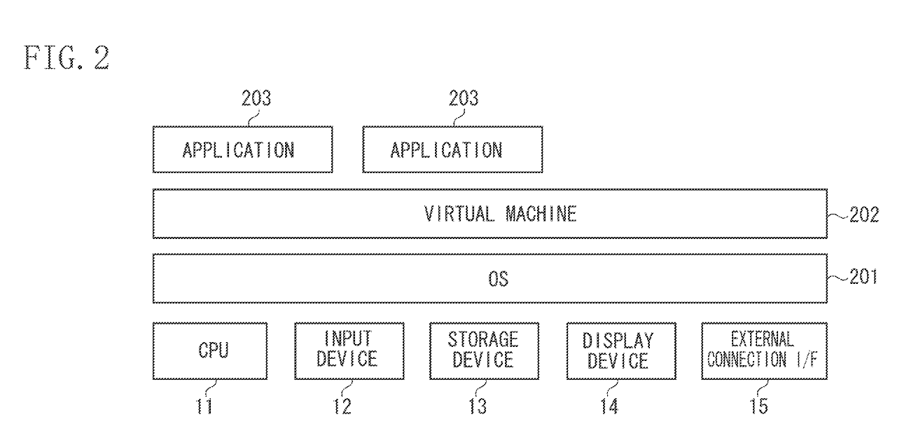

Next, a configuration of a system established on the information processing apparatus 101 is described with reference to FIG. 2. FIG. 2 is a diagram illustrating an example of a configuration of the system of the information processing apparatus 101.

An operating system (OS) 201 is fundamental software for the entire system. The virtual machine 202 is a process on the OS 201, and is software that provides an environment for an application to operate on the virtual machine 202. An application 203 is a program executed on the virtual machine 202.

Specifically, the virtual machine 202 according to the present exemplary embodiment is Java Runtime Environment (JRE). JRE is a software package for executing software developed with the Java (registered trademark) language. JRE includes class library and Java VM (software for executing an application described with the Java language). JRE is installed on the information processing apparatus 101. The information processing apparatus 101 is hereinafter referred to as an apparatus.

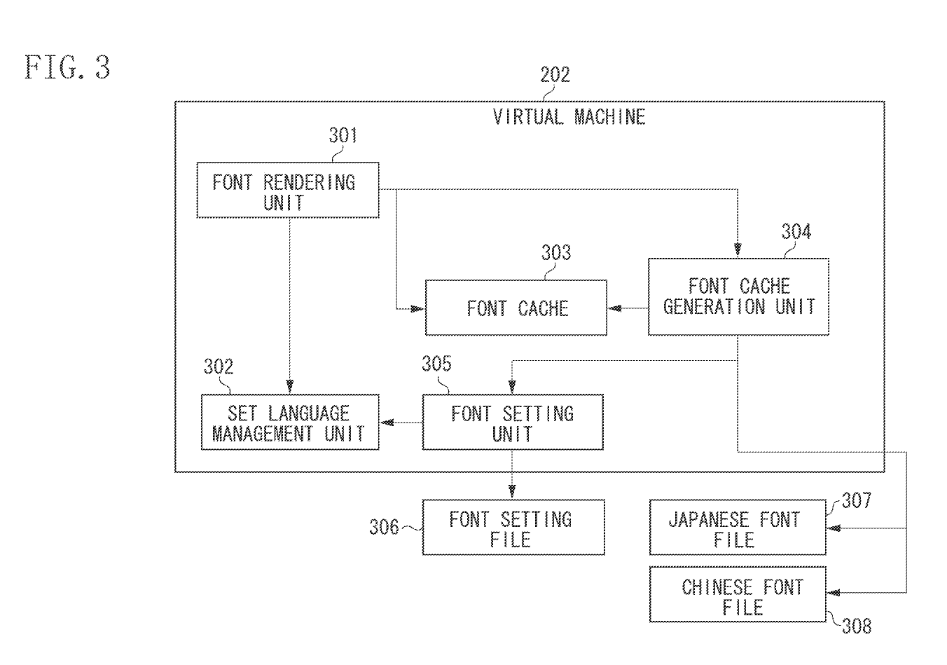

A specific configuration of the virtual machine 202 is described with reference to FIG. 3. FIG. 3 illustrates a function and a related file of the virtual machine 202. In the description below, the apparatus supports two languages (Chinese and Japanese). It is to be noted that the same applies to a case where three or more languages are supported.

Character sets of various languages of the world are defined as Unicode. Generally, a font file is different among languages, and covers the character sets of a corresponding one of the languages.

FIG. 3 indicates that the apparatus includes a Japanese font file 307 and a Chinese font file 308. The font file includes font data for rendering the shapes of the characters.

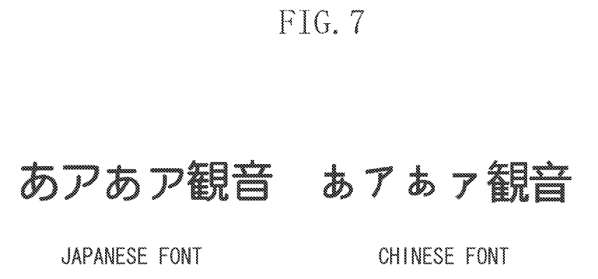

In the Japanese and Chinese character sets, some Japanese Kanji and some Chinese Kanji are the same in a Unicode value corresponding to a Kanji character. Thus, the Japanese font file 307 and the Chinese font file 308 include font data corresponding to the same Unicode value. However, the Japanese font and the Chinese font are different from each other in the font data, and thus are different from each other in an appearance of a rendered character. FIG. 7 illustrates an example of a difference between the Japanese font and the Chinese font. The Chinese font file 308 defines Hiragana characters as well, and thus not only Kanji but also Hiragana involves a difference in the rendering result.

The virtual machine 202 includes a set language management unit 302. The set language management unit 302 sets a language to be displayed by the virtual machine 202, and acquires a setting of the language to be displayed by the virtual machine 202. The language set to the virtual machine 202 is hereinafter referred to as a set language. The set language stored in the set language management unit 302 includes three types of languages that are a “set language at the start of the virtual machine 202”, a “set language currently set to the virtual machine 202”, and a “set language at the time of generation of a font cache 303”. The “set language currently set to the virtual machine 202” may be hereinafter simply referred to as a set language.

The virtual machine 202 includes five logical fonts (serif, sansserif, monospaced, dialog, and dialoginput). Each logical font can support four standard styles (plain, bold, italic, and bolditalic). A logical font can be added in accordance with an execution environment of the apparatus.

A font setting file 306 indicates a standard font configuration file of the Java VM. In the font setting file 306, a font file of the apparatus as well as a setting on an association between logical fonts and styles are described. The virtual machine 202 includes a font setting unit 305 for setting a font based on the description in the font setting file 306.

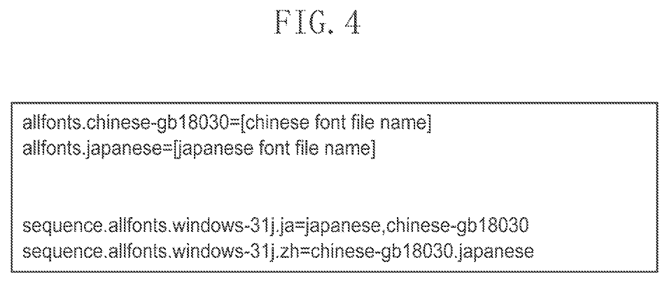

FIG. 4 illustrates an example of the description in the font setting file 306. The first line indicates a location of the Chinese font file with a file name of the Chinese font file 308 written in [chinese font file name]. A file name of the Japanese font file 307 is written in [japanese font file name] in the second line. The third line indicates the search order of font files under the condition that “windows-31j” is set for encoding, and “ja” (Japanese) is set as the set language of the virtual machine 202. The setting in the third line is for searching the Japanese font file 307 and the Chinese font file 308 for the font data in this order. The fourth line indicates the search order of font files under the condition that “windows-31j” is set for encoding, and “zh” (Chinese) is set as the set language of the virtual machine 202. The setting in the fourth line is for searching the Chinese font file 308 and the Japanese font file 307 for the font data in this order.

The font cache 303 is searched for the font data. The font cache 303 is generated using as a key a combination of encoding, a locale, and country set to the virtual machine 202. The locale depends on the set language. Thus, the key depends on the set language of the virtual machine 202. The key is further used for generating the font cache 303 for each style and for each family.

The key is generally generated based on the “set language at the start of the virtual machine 202”, but is generated based on the “set language currently set to the virtual machine 202” in the present exemplary embodiment.

The font cache 303 is a Java object in a memory. The font cache 303 includes a pointer pointing to a file cache that is a result of reading and analyzing the font file. An entity of the file cache is managed by a font cache generation unit 304. The file cache is not deleted until the virtual machine 202 is terminated. The font cache 303 is generated for each logical font name and each style of a font.

In many cases, the font cache 303 includes a plurality of file caches. When there is data on the plurality of file caches, the search of the font data is made in the order corresponding to the search order of the font files written in the font setting file 306. The search order of the font data is different among the set languages, and thus the font cache 303 is different among the set languages.

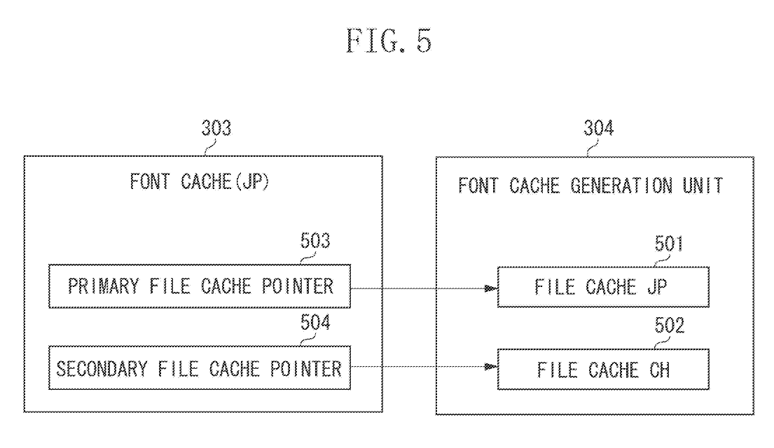

FIG. 5 illustrates the font cache 303 in a case where the set language is Japanese. A file cache JP 501 is a cache obtained as a result of reading the Japanese font file 307. A file cache CH 502 is a cache obtained as a result of reading the Chinese font file 308. The font cache 303 includes a pointer pointing to a file cache so that the file cache JP 501 and the file cache CH 502 can be shared among the plurality of font caches 303. In FIG. 5, a primary file cache pointer 503 is a pointer pointing to the file cache JP 501, and a secondary file cache pointer 504 is a pointer pointing to the file cache CH 502. The font data with an earlier search order has a higher priority, and thus the font cache 303 illustrated in FIG. 5 is configured in such a manner that the search of the font data is made in the order of Japanese and Chinese.

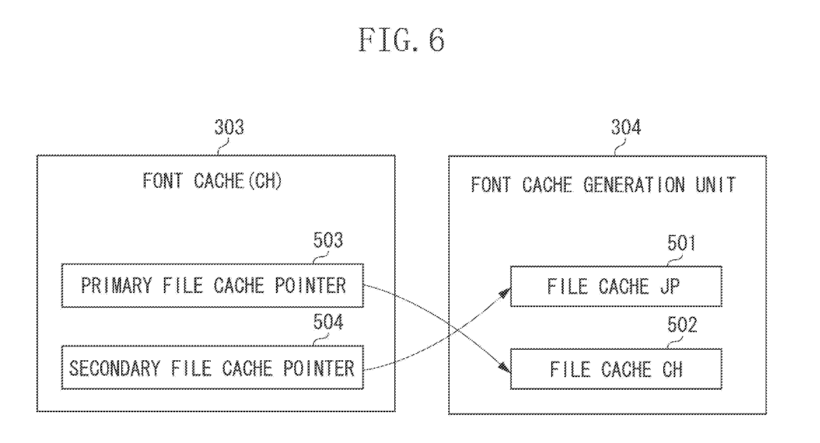

FIG. 6 illustrates the font cache 303 in a case where the set language is Chinese. This figure has components that are the same as those in FIG. 5 with a reversed search order.

The virtual machine 202 includes the font cache generation unit 304 for reading the font file in the information processing apparatus 101 and generating the font cache 303. As described above, the font cache generation unit 304 generates and manages a file cache.

The virtual machine 202 includes a font rendering unit 301 for rendering a character in accordance with a rendering command from the application 203. The font rendering unit 301 acquires font data from the font cache 303 and renders a character.

When a character is rendered, the search of the font data is made with a Unicode value of the rendered character as a key. The file cache JP 501 and the file cache CH 502 have the font data corresponding to the common Unicode value, and thus the font data that is first found by the search is rendered.

A font setting for each set language can be written in the font setting file 306. After the font setting file 306 has been read at the time of starting, the Java VM keeps the setting corresponding to the set language at the time of starting, applied.

The virtual machine 202 might change the set language after being started. When this happens, the displayed font should be changed in accordance with the font setting of the corresponding language. Unfortunately, a general Java VM is incapable of changing fonts in accordance with the change in the set language after the starting.

Thus, a mechanism for changing the font in accordance with the change in the set language is applied. The mechanism is implemented with stating processing, set language change processing, and character rendering processing of the virtual machine 202.

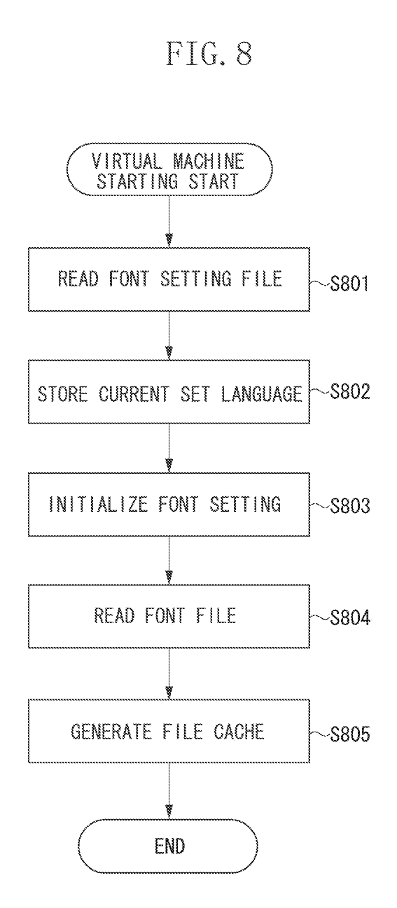

First of all, starting processing of the virtual machine 202 is described with reference to FIG. 8. FIG. 8 is a flowchart illustrating starting processing of the virtual machine 202.

When the starting of the virtual machine 202 starts, the font setting unit 305 reads the font setting file 306 in step S801. A result of the reading is as illustrated in FIG. 4, and is stored in the font setting unit 305 until the virtual machine 202 terminates the operation.

In step S802, the set language management unit 302 in the virtual machine 202 stores the current set language. The language to be set when the virtual machine 202 is started is generally specified by passing an argument when starting the virtual machine 202. The set language management unit 302 analyzes the argument to acquire the set language, and stores the set language as the “set language at the start of the virtual machine 202”, and as the “set language currently set to the virtual machine 202”. Here, the set language is assumed to be Japanese.

In step S803, the font setting unit 305 of the virtual machine 202 initializes the font setting by selecting and applying a setting corresponding to the current set language from among the settings listed in the font setting file 306. The setting is selected by referring to encoding set to the virtual machine 202 and the “set language at the start of the virtual machine 202”. In the described example, the set language in step S802 is Japanese, and the encoding set to the virtual machine 202 is windows-31j. Thus, the setting in the third line in the font setting file 306 is selected.

The setting in the third line in the font setting file 306 is for reading the Japanese font file 307 and the Chinese font file 308. Thus, in step S804, the font cache generation unit 304 in the virtual machine 202 reads the Japanese font file 307 and the Chinese font file 308.

When the font file is read, in step S805, the font cache generation unit 304 generates the file cache JP 501 and the file cache CH 502.

The processing of starting the virtual machine 202 with the font setting file 306 read is as described above.

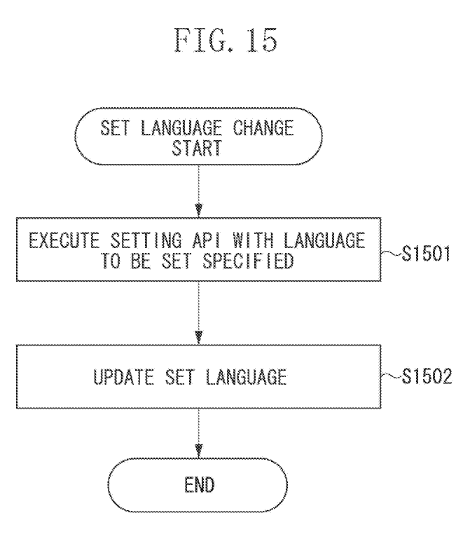

Next, the set language change processing is described with reference to FIG. 15. FIG. 15 is a flowchart illustrating the processing of changing the language set to the virtual machine 202.

After the virtual machine 202 has started, a user changes the set language with the application 203. More specifically, the user operates the application 203 to specify a desired language to be set. Then, in step S1501, the application 203 specifies the language to be set, and executes a setting Application Programming Interface (API) in the virtual machine 202.

When the language setting API is executed, in step S1502, the set language management unit 302 updates the “set language currently set to the virtual machine 202” stored therein.

The set language change processing for the virtual machine 202 is as described above.

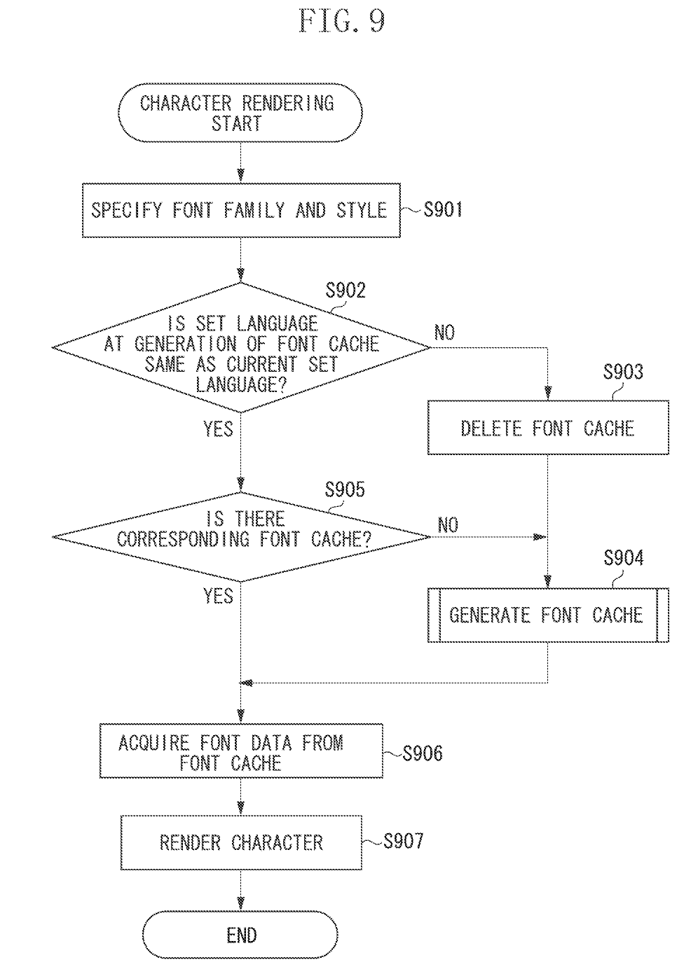

The character rendering processing for switching the displayed font in accordance with the change in the set language after the starting is described with reference to FIG. 9. FIG. 9 is a flowchart illustrating the character rendering processing according to the first exemplary embodiment.

For the application 203 to execute the character rendering command, an instance of a font object (hereinafter, referred to as a font instance) is to be generated in advance. The font instance is generated with a font family, a font size, and a font style specified. The name of the logical font is specified as the font family.

The font rendering unit 301 starts rendering a character by executing the character rendering API provided by the virtual machine 202 with the font instance as the argument. In step S901, the font rendering unit 301 specifies the font family and the font style with the font instance provided as the argument. Then, in step S902, the set language management unit 302 checks whether the “set language at the generation of the font cache 303” is the same as the current set language.

When the set languages are the same (Yes in step S902), the processing proceeds to step S905. In step S905, the font rendering unit 301 checks whether there is the font cache 303 corresponding to the family and the style of the font to be rendered. When there is no such font cache 303 (No in step S905), the processing proceeds to step S904. In step S904, the font rendering unit 301 executes processing of generating the font cache 303. The processing of generating the font cache 303 is described in detail below. FIG. 5 illustrates the font cache 303 generated when the set language at the start of the virtual machine 202 is Japanese, and the set language has not been changed after the start.

When the corresponding font cache 303 is found in step S905 (Yes in step S905) or when the processing in step S904 is completed, the processing proceeds to step S906. In step S906, the font rendering unit 301 acquires font data corresponding to the character to be rendered, from the font cache 303. Then, in step S907, the font rendering unit 301 renders the character by using the acquired font data.

The set languages are determined to be different from each other in step S902 (No in step S902) when the set language is Japanese at the start of the virtual machine 202 and is then changed to Chinese, and the processing proceeds to step S903. In step S903, the font cache generation unit 304 deletes the stored font cache 303, and the processing proceeds to step S904. FIG. 6 illustrates the resultant font cache 303 thus re-generated. The font cache 303 as illustrated in FIG. 6 may be re-generated by partially changing the font cache 303.

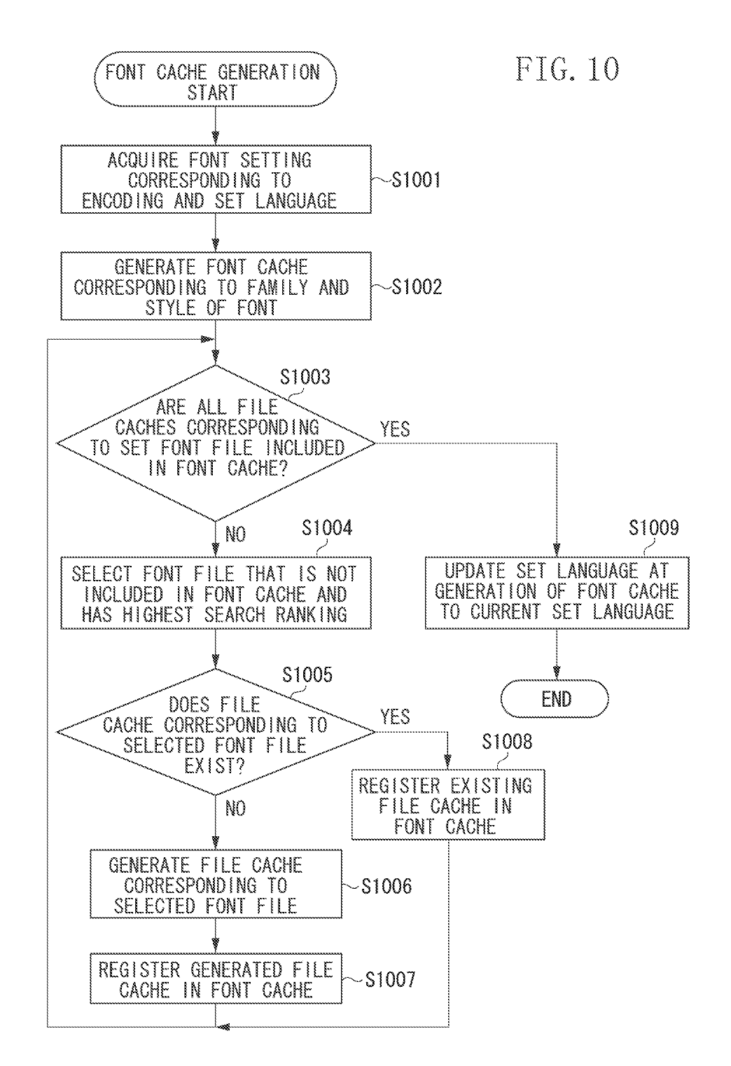

The character rendering processing is as described above. Next, the font cache generation processing is described in detail with reference to FIG. 10. FIG. 10 is a flowchart illustrating the font cache generation processing according to first exemplary embodiment.

In step S1001, the font cache generation unit 304 acquires the font setting corresponding to the encoding and the set language set to the virtual machine 202 by the font setting unit 305. As illustrated in FIG. 4, the specific setting content includes the search order of the fonts and the name of the font file to be searched.

In step S1002, the font cache generation unit 304 generates the font cache 303 corresponding to the font family and the font style specified in step S901.

In step S1003, the font cache generation unit 304 checks whether the font cache 303 includes all the file caches corresponding to the set font file. When none of the file caches are included (No in step S1003), the processing proceeds to step S1004. In step S1004, the font cache generation unit 304 selects one, with an earlier search order, of the font files corresponding to the file caches that are not included in the font cache 303.

In step S1005, the font cache generation unit 304 checks whether there is a file cache corresponding to the selected font file. As described above with reference to FIG. 6, the font cache 303 is a set of pointers to the file caches. Thus, in step S1005, whether the file cache that has been generated can be used for another font cache is checked.

When the file cache is found in step S1005 (YES in step S1005), the processing proceeds to step S1008. In step S1008, the font cache generation unit 304 registers the found file cache in the font cache 303, by generating a pointer pointing to the found file cache.

When no corresponding file cache is found in step S1005 (No in step S1005), the processing proceeds to step S1006. In step S1006, the font cache generation unit 304 generates a file cache corresponding to the selected font file. In step S1007, the font cache generation unit 304 registers the generated file cache in the font cache 303. When the processing in step S1007 is completed, the processing returns to step S1003. Each time the processing in step S1003 is executed, whether one of the font files not registered in the font cache and having the highest priority is registered in the font cache 303 is checked.

When all the file caches are determined to be included in the font cache 303 in step S1003 (Yes in step S1003), the processing proceeds to step S1009. In step S1009, the “set language at the generation of the font cache 303” stored in the set language management unit 302 is updated with the current set language.

The processing of changing the rendering font in accordance with the change in the set language is as described above. After the set language has been switched, the font cache 303 is updated when the first character is rendered. Thus, the virtual machine 202 can perform rendering with the font corresponding to the set language. The font cache 303 is updated with the file cache shared, whereby a cost for changing the rendering font can be reduced with rereading of the font file reduced.

A second exemplary embodiment is described. In the first exemplary embodiment, the processing of changing the rendering font in accordance with a change in the set language has been described. In the first exemplary embodiment, the font of the newly rendered character is changed without changing the font of the character that has already been rendered. When the set language is changed, the character that has been rendered and thus is currently displayed on a screen also is to be rerendered with the changed font.

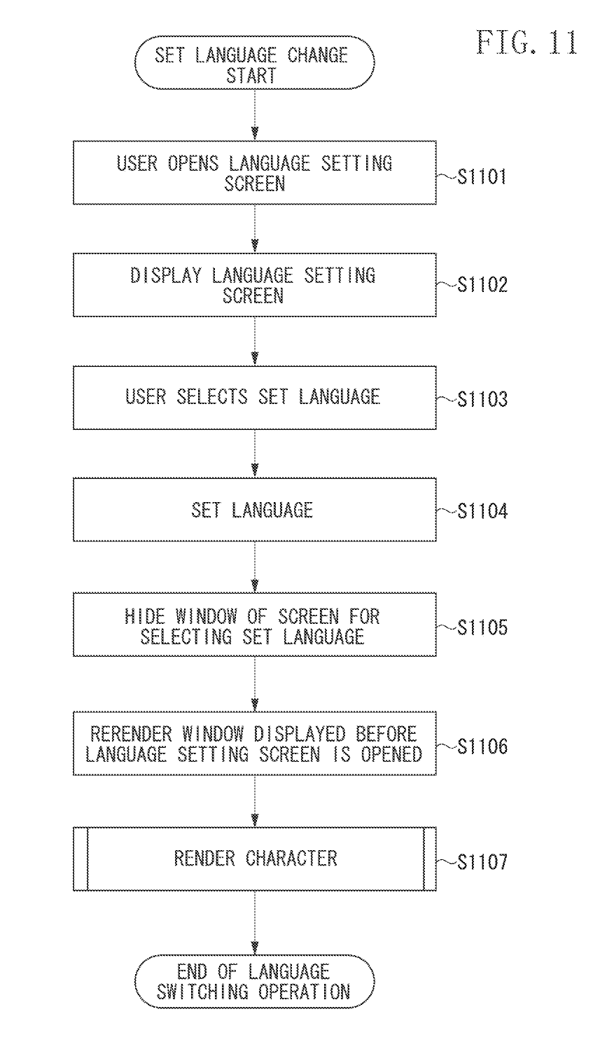

Thus, processing of rerendering the currently displayed character due to the change in the set language is described with reference to FIG. 11. FIG. 11 is a flowchart illustrating set language change processing.

The virtual machine 202 uses a window system, which is X Window System (registered trademark), for screen output. With the window system, when a new window B is displayed over a displayed window A and then the window B is hidden, the window A is rerendered. The rerendering is executed with a rendering instruction issued to the virtual machine 202. Processing executed in response to this rendering instruction issued by the window system is the same as that executed in response to the rendering command issued by the application 203.

An example is described in which the user changes the set language in a state where a screen including a character is displayed on the apparatus by the virtual machine 202. A window C is assumed to be a window in the displayed screen.

In the set language change processing, first of all, in step S1101, a user opens a language setting screen by operating the apparatus. The language setting screen is not illustrated in the figures and is not particularly limited. Then, in step S1102, the language setting screen is displayed. The language setting screen is a window (hereinafter, referred to as a window D) displayed over an area of the screen where the window C is displayed.

In step S1103, the user selects the set language by using a user interface (UI) on the window D. As a result, in step S1104, the set language selected by the user is set as the “set language currently set to the virtual machine 202”.

In step S1105, the apparatus hides the window D for selecting the set language on the screen. As a result, in step S1106, the window C before the language setting screen is opened is rerendered. The rerendering is executed through processing that is the same as that executed in response to the character rendering command issued by the application 203. Thus, in step S1107, the character rendering processing as illustrated in FIG. 9 is executed.

Although not elaborated in the above description focusing only on the rerendering of the window C, all the windows to be displayed again after the set language has been changed are rerendered with the changed font. More specifically, the window hidden behind another window is rerendered by the window system upon being fully displayed.

The processing of changing the font of the character that has been displayed in accordance with the change in the set language is as described above. With the function of the window system, the font can be changed without adding a complicated mechanism to the virtual machine 202.

A third exemplary embodiment is described. The virtual machine 202 does not delete the file cache so that the font file needs not to be reread even when the set language is switched between Japanese and Chinese and thus the cost can be reduced.

Nevertheless, in an execution environment in which the capacity of the memory is insufficient, the capacity of the memory should be increased in view of the risk of causing the rereading of the font file.

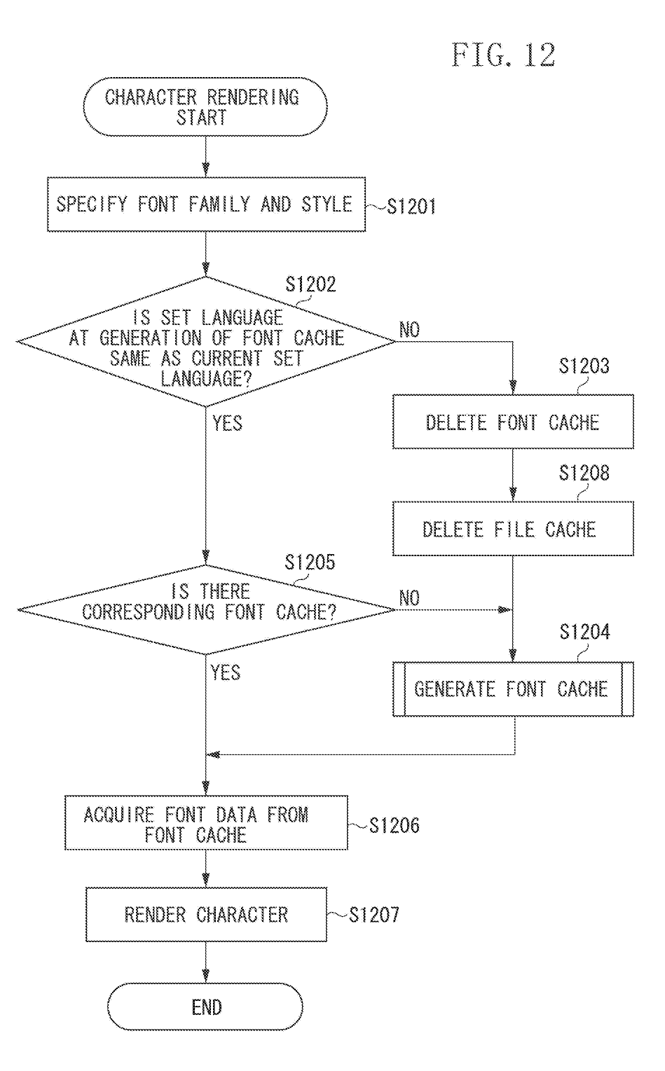

In view of the above, the third exemplary embodiment is described as processing of deleting the file cache when the set language is changed. FIG. 12 is a flowchart illustrating character rendering processing.

Steps S1201 to S1207 respectively are the same as step S901 to S907.

In the present exemplary embodiment, after the processing of deleting the font cache in step S1203 has been completed, the processing proceeds to step S1208. In step S1208, the font rendering unit 301 further deletes all the file caches. As a result, the file cache before the set language is changed can no longer be reused after the set language has been changed, but the memory usage amount can be reduced. The processing of reducing the memory usage amount is as described above.

A fourth exemplary embodiment is described. A timing of changing the font displayed by the virtual machine 202 is not limited to the timing at which the set language is changed. An example is described in which when an external apparatus including a display device is connected with the apparatus on which the virtual machine 202 is operating, the virtual machine 202 renders a screen on the display device of the external apparatus.

In this example, two users respectively are assumed to perform operations with a display device of the apparatus on which the virtual machine 202 is operating and the display device of the external apparatus. In this situation, the user using the display device of the apparatus on which the virtual machine 202 is operating may desire to use the Japanese font, whereas the user using the display device of the external apparatus may desire to use the Chinese font, under a condition that Japanese is set as the common set language. In such a case, when the font for the external apparatus can be set in such a manner that the Chinese font can be prioritized compared with the Japanese set as the common set language, Kanjis in the Chinese font can be displayed on the display device of the external apparatus.

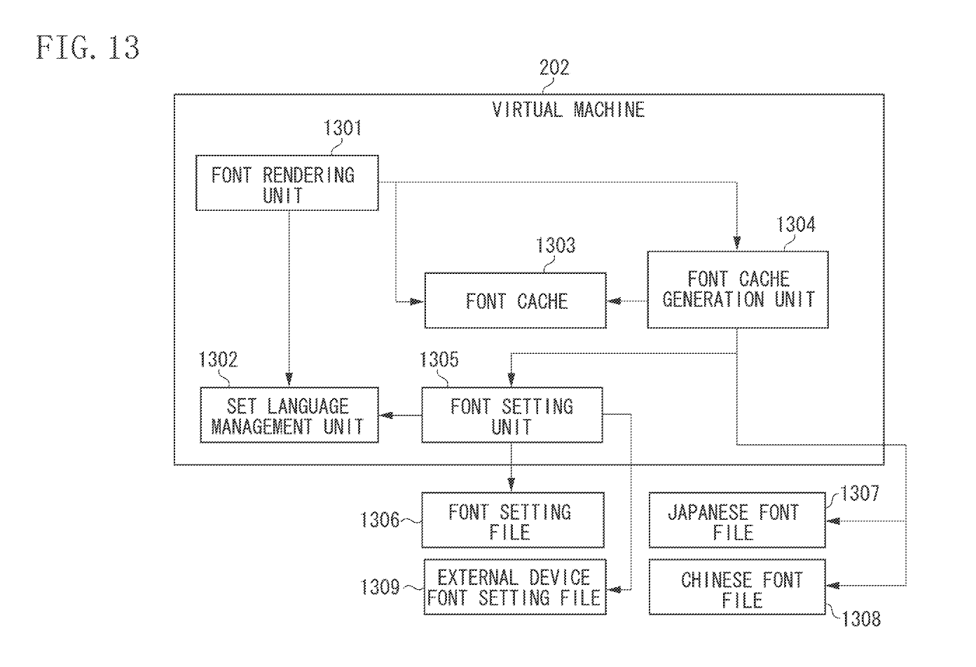

Thus, the fourth exemplary embodiment is described as processing of switching the font when the external apparatus is connected. FIG. 13 is a schematic view illustrating a configuration of a virtual machine that is different from that in FIG. 3 in that an external apparatus font setting file 1309 is provided.

A font setting corresponding to a screen of the external apparatus is described in the external apparatus font setting file 1309. The file may be transmitted from the external apparatus to the apparatus when the external apparatus is connected to the apparatus, or may be stored in the system of the apparatus in advance. Here, it is assumed that the external apparatus font setting file 1309 and a font setting file 1306 are different from each other in the right side in the third line. More specifically, the external apparatus font setting file 1309 has “chinese-gb18030,japanese”, whereas the font setting file 1306 has “japanse,chinese-gb18030”. A font setting unit 1305 reads the external apparatus font setting file 1309 and stores the external apparatus font setting.

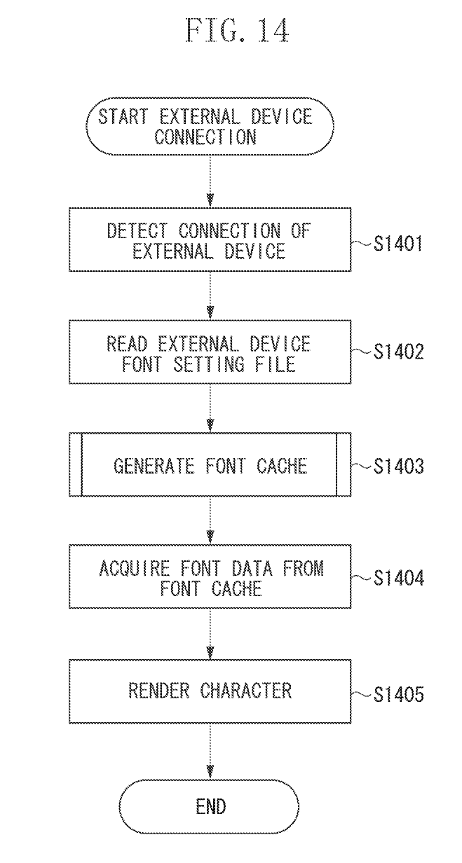

Processing of changing the displayed font in response to the connection of the external apparatus is described with reference to FIG. 14. FIG. 14 is a flowchart illustrating external apparatus connection processing.

When the external apparatus is connected, in step S1401, the virtual machine 202 detects the connection of the external apparatus. A method for the detection may involve execution of the API provided to the virtual machine 202 by the OS 201, but is not particularly limited. In step S1402, the font setting unit 1305 reads the external apparatus font setting file 1309 and stores the external apparatus font setting.

In step S1403, a font cache generation unit 1304 generates a font cache 1303 based on the external apparatus font setting. As a result, the virtual machine 202 includes two types of font caches 1303 for the apparatus and the external apparatus. The two types of font caches 1303 are managed independently from each other. In the first exemplary embodiment, the font cache 1303 is generated using as a key the combination of the encoding, the locale, and the country set to the virtual machine 202. In the fourth exemplary embodiment, the font caches 1303 can be easily managed independently from each other with an ID of the apparatus or an ID of the external apparatus combined with the key. More specifically, the first exemplary embodiment employs “key=encoding+locale (set language)+country”, whereas the fourth exemplary embodiment employs “key=encoding+locale (set language)+country+(ID of the apparatus or ID of the external apparatus)”.

The processing in step S1403 is the same as the processing of generating the font cache in FIG. 10, except for the difference in the key for managing the font cache 1303.

After the font cache 1303 has been generated, the processing proceeds to step S1404 in which a font rendering unit 1301 acquires font data as in step S906. Then, in step S1405, the font rendering unit 1301 renders the character as in step S907.

Processing of changing the displayed font in response to the connection of the external apparatus is as described above.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2016-109338, filed May 31, 2016, which is hereby incorporated by reference herein in its entirety.

What is claimed is:

1. An apparatus in which an application is operated on a virtual machine, the apparatus comprising:
a setting unit configured to set a font corresponding to a set language of the virtual machine;
a font cache generation unit configured to read a font file corresponding to the set font, and generate a font cache including a pointer pointing to a cache of the font file;
a control unit configured to display a font used for the application on a display device, by using the font cache; and
a change unit configured to change the font cache, when the set language of the virtual machine is changed.

2. The apparatus according to claim 1, wherein the control unit is configured to rerender a display on the display device, when the set language of the virtual machine is changed.

3. The apparatus according to claim 1, wherein the change unit is configured to delete the font cache and re-generate a font cache, when the set language of the virtual machine is changed.

4. The apparatus according to claim 1, wherein the change unit is configured to delete the cache of the font file, when the set language of the virtual machine is changed.

5. The apparatus according to claim 1, wherein the change unit is configured to change the font cache, based on a font setting of an external apparatus, when the external apparatus is connected to the apparatus.

6. The apparatus according to claim 1, wherein the setting unit is configured to set the set language of the virtual machine based on a selection made by a user.

7. A method for an apparatus in which an application is operated on a virtual machine, the method comprising:
setting a font corresponding to a set language of the virtual machine;
reading a font file corresponding to the set font, and generating a font cache including a pointer pointing to a cache of the font file;
performing control to display a font used for the application on a display device, by using the font cache; and
changing the font cache, when the set language of the virtual machine is changed.

8. The method according to claim 7, further comprising rerendering a display on the display device, when the set language of the virtual machine is changed.

9. The method according to claim 7, further comprising deleting the font cache and re-generating a font cache, when the set language of the virtual machine is changed.

10. The method according to claim 7, further comprising deleting the cache of the font file, when the set language of the virtual machine is changed.

11. The method according to claim 7, further comprising changing the font cache, based on a font setting of an external apparatus, when the external apparatus is connected to the apparatus.

12. The method according to claim 7, wherein the setting comprises setting the set language of the virtual machine based on a selection made by a user.

13. A non-transitory storage medium storing a program causing a computer to execute a method involving an operation of an application on a virtual machine, the method comprising:
setting a font corresponding to a set language of the virtual machine;
reading a font file corresponding to the set font, and generating a font cache including a pointer pointing to a cache of the font file;
performing control to display a font used for the application on a display device, by using the font cache; and
changing the font cache, when the set language of the virtual machine is changed.

14. The non-transitory storage medium according to claim 13, further comprising rerendering a display on the display device, when the set language of the virtual machine is changed.

15. The non-transitory storage medium according to claim 13, further comprising deleting the font cache and re-generating a font cache, when the set language of the virtual machine is changed.

16. The non-transitory storage medium according to claim 13, further comprising deleting the cache of the font file, when the set language of the virtual machine is changed.

17. The non-transitory storage medium according to claim 13, further comprising changing the font cache, based on a font setting of an external apparatus, when the external apparatus is connected to an apparatus in which the application is operated on the virtual machine.

18. The non-transitory storage medium according to claim 13, wherein the setting comprises setting the set language of the virtual machine based on a selection made by a user.
